(19) United States
(12) Patent Application Publication
(10) Pub. No.: US 2014/0260784 A1
(43) Pub. Date: Sep. 18, 2014

(54) Pedal And Crank System

(71) Applicants: Arnold Kamler, Montville, NJ (US); Sylvester H. Yen, Short Hills, NJ (US)

(72) Inventors: Arnold Kamler, Montville, NJ (US); Sylvester H. Yen, Short Hills, NJ (US)

(21) Appl. No.: 13/827,130

(22) Filed: Mar. 14, 2013

(51) Int. Cl. B62M 3/08

(52) U.S. Cl. CPC B62M 3/08
USPC 74/594.4; 29/428; 29/456; 29/525.01

(57) ABSTRACT

A crank arm system for a cycle is provided including a first crank arm, a second crank arm, a first crank arm end, and a second crank arm end. The first crank arm has a length extending along a first plane. The second crank arm has a length extending along a second plane. The first crank arm end has a pedal coupling portion and a crank arm coupling portion having a length configured to extend along either the first or second plane when coupled to the respective first or second crank arm. The second crank arm end has a pedal coupling portion and a crank arm coupling portion having a length configured to extend along either the first or second plane when coupled to the respective first or second crank arm.

### FIELD

The present application relates to pedal and crank systems. More particularly, the present application relates to pedal and crank systems having removable pedal subassemblies.

### BACKGROUND

Pedal powered cycles, such as bicycles, tricycles, unicycles, and the like, are used by people of all ages for recreational activities, commuting, exercise, and other purposes. In this regard, such cycles include pedals which are used to directly and/or indirectly power one or more wheels of the cycle.

However, when pedal powered cycles are packaged and transported, such as for sale, they are typically at least partially disassembled. In this regard, the pedals, which generally protrude outwardly, would become entangled with other pedals and structures of the bicycle as well as with other structures that are being shipped with the cycle if they were to have been installed at the factory. Further, the protruding pedals can scratch and damage walls and other surfaces when transported. Therefore, to overcome such issues, pedal powered cycles often have at least the pedals removed from the cycle.

Generally, most pedals are attached to the crank by external threading found on the pedal axle which corresponds to a threaded bore on the end of the crank arm. Typically, the threads are either right or left handed so as to tighten as the crank is pedaled in a forward direction. However, such right and left-handed threads can make it difficult for purchasers to assemble. For example, a customer may not readily identify markings indicating that one pedal is a right-hand side pedal whereas the other pedal is a left-hand side pedal. In such a situation, the customer may damage or destroy the threads while attempting to install a pedal on the wrong side of the cycle. Moreover, depending on the design of the threads, such as the pitch, depth, and the like, the threads can be easily misaligned and therefore cross-threaded or otherwise stripped.

Further, it may be desirable to have pedals which are readily removable, such as for storage or transport by the customer. For example, a parent may wish to load up and transport a number of bicycles for younger children, but the pedals may become entangled or otherwise make it difficult to stack the cycles in an efficient manner. Therefore, it may be desirable to have the crank arms and/or pedals as removable components. Moreover, it may be desirable to have such removable pedals be quickly re-attachable to the cycle.

### SUMMARY

In one form, it has unexpectedly been found that a crank arm system can be provided whereby a cycle may be shipped and then later assembled by a customer in a generally simplified manner. Moreover, in one form, pedal subassemblies can be assembled at a factory and then later installed as part of a crank arm system by a customer. According to one form, the pedal subassemblies can be prepared such that a subassembly can be installed on either the left-hand side or the right-hand side of the cycle. Moreover, in one form, as the pedal subassemblies can be installed on either side, a replacement subassembly can be used to replace a broken pedal without having to purchase a specific right-hand or left-hand side subassembly.

According to one form, a crank arm system for a cycle is provided. The crank arm system includes a first crank arm, a second crank arm, a first crank arm end, and a second crank arm end. The first crank arm has a length extending along a first plane. The second crank arm has a length extending along a second plane. The first crank arm end has a pedal coupling portion and a crank arm coupling portion. The crank arm coupling portion has a length configured to extend along either the first or second plane when coupled to the respective first or second crank arm. The second crank arm end has a pedal coupling portion and a crank arm coupling portion. The crank arm coupling portion has a length configured to extend along either the first or second plane when coupled to the respective first or second crank arm.

In accordance with one form, a crank arm system for a cycle is provided. The crank arm system includes a first crank arm, a second crank arm, a first crank arm end, a second crank arm end, a first pedal, and a second pedal. The first crank arm has a length extending along a first plane. The second crank arm has a length extending along a second plane. The first crank arm end has a pedal coupling portion and a crank arm coupling portion. The crank arm coupling portion has a length configured to extend along the first plane when coupled to the first crank arm. The second crank arm end has a pedal coupling portion and a crank arm coupling portion. The crank arm coupling portion has a length configured to extend along the second plane when coupled to the second crank arm. The first pedal is operably coupled to the pedal coupling portion of the first crank arm end and extends substantially perpendicular to the first plane. The second pedal is operably coupled to the pedal coupling portion of the second crank arm end and extends substantially perpendicular to the second plane.

In one form, each of the first and second pedals include an externally threaded portion and each of the pedal coupling portions of the first and second crank arm ends includes internally threaded portions configured to receive the externally threaded portion of at least one of the first and second pedals.

According to one form, the first and second crank arms each have a female end portion configured to receive the crank arm coupling portion of at least one of the first and second crank arm ends.

In accordance with one form, the crank arm system further includes a plurality of fasteners to secure the first and second crank arm ends to the respective crank arms.

In one form, the crank arm coupling portions of the first and second crank arm ends each includes a flared portion configured to contact at least one of the first and second crank arms.

According to one form, a method of assembling a crank arm system for a cycle is provided. The method includes the steps of: providing a first crank arm having a length extending along a first plane; providing a second crank arm having a length extending along a second plane; providing a first pedal subassembly, the first pedal subassembly including a first crank arm end having a first pedal operably coupled to a pedal coupling portion and a crank arm coupling portion; providing a second pedal subassembly, the second pedal subassembly including a second crank arm end having a second pedal operably coupled to a pedal coupling portion and a crank arm coupling portion; securing the first pedal subassembly to the first crank arm so that the crank arm coupling portion of the first pedal subassembly extends along the first plane; and securing the second pedal subassembly to the second crank arm so that the crank arm coupling portion of the second pedal subassembly extends along the second plane.

### BRIEF DESCRIPTION OF THE DRAWINGS

FIG. 1 is a side perspective view of a portion of a crank arm system for a cycle;

FIG. 2 is a front view of a crank arm system for a cycle with a portion of the crank arm system shown in an exploded form;

FIG. 3 is a perspective view of a crank arm system installed on a bicycle; and

FIG. 4 is a perspective view of a crank arm system installed on a tricycle.

### DETAILED DESCRIPTION

Generally, a crank arm system is provided which, in one form, is shipped with a cycle and then later assembled by a customer in a generally simplified manner. Moreover, in one form, pedal subassemblies can be assembled at a factory and then later installed as part of a crank arm system by a customer. Furthermore, the pedal subassemblies can be prepared such that a subassembly can be installed on either the left-hand side or the right-hand side of the cycle.

It should be noted that the term cycle refers to any pedal powered device including, but not limited to, unicycles, bicycles, tricycles, and the like. In this regard, the crank arm system may be in the form of a hub, such as the case for many unicycles and child tricycles, thereby directly powering one or more wheels. In another form, the crank arm system may be configured with one or more gears, such as often the case with many bicycles, to thereby indirectly power one or more wheels. Additionally, such cycles can include baby, toddler, child, adult, and the like type cycles. Other uses and configurations for the crank arm system are also contemplated.

As shown in FIG. 1, one form of a crank arm system 10 is illustrated. In this form, the crank arm system 10 is directly powering a wheel 12 via a hub 14. However, as noted above, the crank arm system 10 may also indirectly power a wheel, such as via one or more gears (not shown).

As best seen in FIGS. 1 and 2, the crank arm system 10 includes a first crank arm 16, a second crank arm 18, a first crank arm end 20, and a second crank arm end 22. The first crank arm 16 has a length that extends generally along a first plane, represented by line 24. Similarly, the second crank arm 18 has a length that extends generally along a second plane, represented by line 62. It should be noted that in some forms, the first and second planes 24, 26 generally extend along the up and down directions in accordance with how a user might extend his or her legs when riding the cycle.

Furthermore, the first and second crank arms 16, 18 may be coupled to one another in a variety of different manners. As shown in FIG. 2, the first and second crank arms 16, 18 are coupled to one another via the hub 14. The first and second crank arms 16, 18 may also be coupled to one another via a central point or gear (not shown) such as in the case of a geared bicycle. The first and second crank arms 16, 18 may also be coupled together via other intermediate components. In one form, the crank arms 16, 18 may form a single, integral piece. In another form, the first and second crank arms 16, 18 are separate pieces that are coupled together such as via welding, fasteners, and the like.

Referring to FIGS. 1 and 2, the first crank arm end 20 is shown detached from the first crank arm 16 while FIG. 2 illustrates the second crank arm end 22 coupled to the second crank arm 18. In one form, the first and second crank arm ends 20, 22 are configured in the same manner and may generally be identical.

Each of the first and second crank arm ends 20, 22 include a pedal coupling portion and a crank arm coupling portion. For example, the first crank arm end 20 includes a pedal coupling portion 30 and a crank arm coupling portion 32. The pedal coupling portion 30 is generally configured to couple a pedal to the crank arm end 20. In this regard, in one form, the pedal coupling portion 32 can include a threaded bore 34 to receive a portion of a pedal, as will be described below in more detail. It should be noted that the pedal coupling portion 30 may take a variety of other forms, such as a protrusion that is configured to coordinate with an opening in the pedal (not shown). Other methods and structures for coupling the pedal coupling portion 32 to a pedal are also contemplated.

The crank arm coupling portion 32 includes a length that is configured to extend along either the first or second planes 24, 26 when coupled to the respective first or second crank arm 16, 18. As shown in FIG. 1, the crank arm coupling portion 32 is generally cylindrical and includes a flared portion 36. When coupled to a crank arm 16, 18, the flared portion 36 may be used to help center and secure the crank arm end 20 and also help eliminate movement and/or vibration during intended use. Further, in one form, the crank arm coupling portion 32 may include an aperture 38 that can also be used to help secure the crank arm end 20 to the first crank arm 16.

As shown in the figures, the pedal coupling portion 30 and crank arm portion 32 are in the form of a single, integral component, though they may also take the form of separate components that are secured together. Further, as shown in FIGS. 1 and 2, the first crank arm end 20 is generally shown as having a “male” end, such as at the crank arm coupling portion 32. In this regard, the crank arm coupling portion 32 may be considered to be a male end that is inserted into a female end 40 of the first crank arm 16. However, it should be noted that the crank arm end 20 may instead include a female end with the crank arm 16 having a male end. Other forms for the crank arm end 20 and crank arm 16 are also contemplated.

The crank arm system 10 may also include a first pedal 42 and a second pedal 44. As best seen in FIG. 2, in one form, pedal 42 includes an axle 46 having threads 48 which are configured to cooperate with the threaded bore 34. Other forms of securing the pedals 42, 44 to the respective crank arm ends 20, 22 are also contemplated including, but not limited to, snap-fit, retaining clips, and the like. In one form, the pedals 42, 44 are installed on the respective crank arm ends 20, 22 at the factory. The pedals 42, 44 can be designed and installed in a permanent and/or removable manner from the crank arm ends 20, 22. The pedals 42, 44 can include any type of pedals, including standard pedals, children's pedals, clip-in pedals, and the like.

As shown in the figures, when installed, the pedals generally extend from the crank arm ends 20, 22 in a direction that is substantially perpendicular to the first and second planes 24, 26. In this regard, the connection between the crank arm 16, 18 and the respective crank arm end 20, 22 may be configured to counteract the forces applied to the pedals 42, 44. Generally, the forces will be in a downward direction, but may also include a rotational component as the pedals 42, 44 extend outward from the crank arm ends 20, 22. In this regard a certain amount of torque may be applied and the connection between the crank arm 16, 18 and the respective crank arm end 20, 22 is suitable to resist such forces without breaking and/or substantial deflection during the intended use.

The crank arm system 10 may also include one or more fasteners. For example, as shown in FIG. 2, two fasteners 50 are shown. Generally, the fasteners 50 can be used to secure the crank arm ends 20, 22 to the crank arms 16, 18. The fasteners 50 can include a variety of different types of fasteners including, but not limited to, screws, bolts, nuts, retaining clips, rivets, snap-fit connections, and the like.

In one form, the crank arm ends 20, 22 are removable from the crank arms 16, 18 by a user after installation. In another form, the crank arm ends 20, 22 are not configured to be easily removable by a user after installation.

Further, in one form, the crank arm ends 20, 22 are configured to be interchangeable. In other words, each of crank arm ends 20, 22 may be designed to be installed on either of crank arms 16, 18. In this regard, a customer does not need to determine which crank arm end 20, 22 is supposed to be installed on which side of the crank arm system 10. In other forms, the crank arm ends 20, 22 can be side specific and can include indicators as to which side the respective crank arm end 20, 22 is supposed to be installed. In this regard, the crank arm 16, 18 and/or crank arm ends 20, 22 can be keyed so as to only fit a specific side.

Referring now to FIG. 3, a crank arm system 60 is shown as installed on a bicycle 62. In this form, the crank arm system 60 is coupled to gears and/or a chain (not shown) to drive one or more wheels. Another form is shown in FIG. 4 whereby a crank arm system 64 is shown as installed on a child's tricycle 66. In this form, the crank arm system 64 is coupled to a hub to directly drive a front wheel 68.

It should be noted that the crank arm system may be manufactured from a number of different materials and/or combinations of materials. Such materials may include plastic, metal, fiberglass, carbon fiber, composites, and the like. For example, in one form, the crank arms and crank arm ends may be manufactured from metals including, but not limited to, steel, aluminum, and the like. The pedals may also be made from a variety of different materials.

While the system and structure have been particularly described with specific reference to particular embodiments, it will be appreciated that various alterations, modifications, and adaptations may be based on the present disclosure, and are intended to be within the spirit of this disclosure.

What is claimed is:

1. A crank arm system for a cycle comprising:
a first crank arm having a length extending along a first plane;
a second crank arm having a length extending along a second plane;
a first crank arm end having a pedal coupling portion and a crank arm coupling portion, the crank arm coupling portion having a length configured to extend along either the first or second plane when coupled to the respective first or second crank arm; and
a second crank arm end having a pedal coupling portion and a crank arm coupling portion, the crank arm coupling portion having a length configured to extend along either the first or second plane when coupled to the respective first or second crank arm.

2. The crank arm system of claim 1 further comprising first and second pedals coupled to the pedal coupling portions of the respective first and second crank arm ends.

3. The crank arm system of claim 2 wherein the first pedal extends substantially perpendicular to the first plane and the second pedal extends substantially perpendicular to the second plane.

4. The crank arm system of claim 2 wherein each of the first and second pedals include an externally threaded portion and each of the pedal coupling portions of the first and second crank arm ends includes internally threaded portions configured to receive the externally threaded portion of at least one of the first and second pedals.

5. The crank arm system of claim 1 wherein the first and second crank arms each have a female end portion configured to receive the crank arm coupling portion of at least one of the first and second crank arm ends.

6. The crank arm system of claim 1 further comprising a plurality of fasteners to secure the first and second crank arm ends to the respective crank arms.

7. The crank arm system of claim 1 wherein the crank arm coupling portions of the first and second crank arm ends each includes a flared portion configured to contact at least one of the first and second crank arms.

8. A crank arm system for a cycle comprising:
a first crank arm having a length extending along a first plane;
a second crank arm having a length extending along a second plane;
a first crank arm end having a pedal coupling portion and a crank arm coupling portion, the crank arm coupling portion having a length configured to extend along the first plane when coupled to the first crank arm;
a second crank arm end having a pedal coupling portion and a crank arm coupling portion, the crank arm coupling portion having a length configured to extend along the second plane when coupled to the second crank arm;
a first pedal operably coupled to the pedal coupling portion of the first crank arm end, the first pedal extending substantially perpendicular to the first plane; and
a second pedal operably coupled to the pedal coupling portion of the second crank arm end, the second pedal extending substantially perpendicular to the second plane.

9. The crank arm system of claim 8 wherein each of the first and second pedals includes an externally threaded portion and each of the pedal coupling portions of the first and second crank arm ends includes internally threaded portions configured to receive the externally threaded portion of at least one of the first and second pedals.

10. The crank arm system of claim 8 wherein the first and second crank arms each have a female end portion configured to receive the crank arm coupling portion of at least one of the first and second crank arm ends.

11. The crank arm system of claim 8 further comprising a plurality of fasteners to secure the first and second crank arm ends to the respective crank arms.

12. The crank arm system of claim 8 wherein the crank arm coupling portions of the first and second crank arm ends each includes a flared portion configured to contact at least one of the first and second crank arms.

13. A method of assembling a crank arm system for a cycle comprising:
providing a first crank arm having a length extending along a first plane;
providing a second crank arm having a length extending along a second plane;
providing a first pedal subassembly, the first pedal subassembly including a first crank arm end having a first pedal operably coupled to a pedal coupling portion and a crank arm coupling portion;
providing a second pedal subassembly, the second pedal subassembly including a second crank arm end having a second pedal operably coupled to a pedal coupling portion and a crank arm coupling portion;
securing the first pedal subassembly to the first crank arm so that the crank arm coupling portion of the first pedal subassembly extends along the first plane; and
securing the second pedal subassembly to the second crank arm so that the crank arm coupling portion of the second pedal subassembly extends along the second plane.

14. The method of claim 13 wherein each of the first and second pedals includes an externally threaded portion and each of the pedal coupling portions of the first and second crank arm ends includes internally threaded portions configured to receive the externally threaded portion of at least one of the first and second pedals.

15. The method of claim 13 wherein the first and second crank arms each have a female end portion configured to receive the crank arm coupling portion of at least one of the first and second crank arm ends.

16. The method of claim 13 further comprising installing a fastener to secure each of the first and second crank arm ends to the respective crank arms.

17. The method of claim 13 wherein the crank arm coupling portions of the first and second crank arm ends each includes a flared portion configured to contact at least one of the first and second crank arms.
